(19) United States
(12) Patent Application Publication
(10) Pub. No.: US 2025/0306421 A1
(43) Pub. Date: Oct. 2, 2025

(54) ELECTRONIC DEVICE

(71) Applicant: InnoLux Corporation, Miao-Li County (TW)

(72) Inventors: Cheng-Ze LIN, Miao-Li County (TW); Kuan-Ting TUNG, Miao-Li County (TW); Hong-Sheng HSIEH, Miao-Li County (TW)

(73) Assignee: InnoLux Corporation, Miao-Li County (TW)

(21) Appl. No.: 19/064,603

(22) Filed: Feb. 26, 2025

(30) Foreign Application Priority Data
Mar. 28, 2024 (CN) 202410361540.6

(51) Int. Cl. G02F 1/1343; G02F 1/1362; G02F 1/1368

(52) U.S. Cl. CPC G02F 1/134327; G02F 1/13439; G02F 1/136286; G02F 1/1368

(57) ABSTRACT

An electronic device includes a substrate, a first transparent conductive layer disposed on the substrate, an insulating layer disposed on the first transparent conductive layer, and a second transparent conductive layer disposed on the insulating layer. The insulating layer has a thickness. The second transparent conductive layer has a transparent electrode including a plurality of finger portions, a connecting portion, and a slit. One of the finger portions has a width in a first direction, and the connecting portion connects the finger portions. The slit is disposed between two adjacent ones of the finger portions, and a distance is between the two adjacent ones of the finger portions in the first direction. A ratio of the distance and the width and the thickness complies with following equation: 1.450×X+0.877≤Y≤1.450×X+1.177, where X is the thickness in microns, and Y is the ratio of the distance and the width.

### BACKGROUND OF THE DISCLOSURE

### 1. Field of the Disclosure

The present disclosure relates to an electronic device and particularly to an electronic device with a displaying function.

### 2. Description of the Prior Art

With the development of technology, electronic devices with a displaying function have been applied to everyday life. In a liquid crystal display device, for example, a fringe field switching (FFS) type liquid crystal display, slits have to be formed in the transparent conductive layer adjacent to the liquid crystal layer, such that a voltage difference between the pixel electrode and the common electrode both on the same side of the liquid crystal layer may be used to control a gray scale value of the pixel. However, there will be some process variations during forming the slits, so that different pixels or different portions of the same pixel may display uneven brightness in middle and low gray scale values. Accordingly, Mura phenomenon may occur on images, which causes a problem of poor display quality.

### SUMMARY OF THE DISCLOSURE

It is an objective of the present disclosure to provide an electronic device to solve the aforementioned problem.

An embodiment of the present disclosure discloses an electronic device including a substrate, a first transparent conductive layer, an insulating layer, and a second transparent conductive layer. The first transparent conductive layer is disposed on the substrate. The insulating layer is disposed on the first transparent conductive layer, and the insulating layer has a thickness. The second transparent conductive layer is disposed on the insulating layer, wherein the second transparent conductive layer includes a transparent electrode, and the transparent electrode includes a plurality of finger portions, a connecting portion, and a slit. One of the finger portions has a width in a first direction, and the connecting portion is connected to the finger portions. The slit is disposed between two adjacent ones of the finger portions, and a distance in the first direction is between the two adjacent ones of the finger portions, wherein a relation of a ratio of the distance to the width and the thickness complies with a following equation:

$$1. 450 \times X + 0.877 \leq Y \leq 1.4 \; 50 \times X + 1.177 ,$$

wherein X is the thickness, a unit of the thickness is micrometer, and Y is the ratio of the distance to the width.

In the electronic device of the present disclosure, since the thickness of the insulating layer disposed between the first transparent conductive layer and the second transparent conductive layer and the ratio of the distance between two adjacent finger portions to the width of the finger portion complies with the above-mentioned equation, the degree of visibility of the Mura phenomenon and/or the probability of occurrence of the Mura phenomenon produced on the image due to process variation may be reduced, such that the display quality and/or the consistency of the quality of the electronic device may be enhanced.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 schematically illustrates a top view of an electronic device according to a first embodiment of the present disclosure.

FIG. 2 schematically illustrates a cross-sectional view along a line A-A′ in FIG. 1.

FIG. 3 schematically illustrates a relation of a ratio of a distance between two adjacent finger portions to a width of a finger portion and a thickness of an insulating layer of the present disclosure.

FIG. 4 schematically illustrates a top view of an electronic device according to a second embodiment of the present disclosure.

FIG. 5 schematically illustrates a cross-sectional view along a line B-B′ in FIG. 4.

FIG. 6 schematically illustrates a top view of an electronic device according to a third embodiment of the present disclosure.

FIG. 7 schematically illustrates a cross-sectional view along a line C-C′ in FIG. 6.

FIG. 8 schematically illustrates a top view of a first transparent electrode according to a fourth embodiment of the present disclosure.

### DETAILED DESCRIPTION

The contents of the present disclosure will be described in detail with reference to specific embodiments and drawings. It is noted that, for purposes of illustrative clarity and being easily understood by the readers, the following drawings may be simplified schematic diagrams, and elements therein may not be drawn to scale. The numbers and sizes of the elements in the drawings are just illustrative and are not intended to limit the scope of the present disclosure.

Certain terms are used throughout the specification and the appended claims of the present disclosure to refer to specific elements. Those skilled in the art should understand that electronic equipment manufacturers may refer to an element by different names, and this document does not intend to distinguish between elements that differ in name but not function.

In the following specification and claims, the terms “comprise”, “include” and “have” are open-ended fashion, so they should be interpreted as “including but not limited to . . . ”.

The ordinal numbers used in the specification and the appended claims, such as “first”, “second”, etc., are used to describe the elements of the claims. It does not mean that the element has any previous ordinal numbers, nor does it represent the order of a certain element and another element, or the sequence in a manufacturing method. These ordinal numbers are just used to make a claimed element with a certain name be clearly distinguishable from another claimed element with the same name.

Spatially relative terms, such as “above”, “on”, “beneath”, “below”, “under”, “left”, “right”, “before”, “front”, “after”, “behind” and the like, used in the following embodiments just refer to the directions in the drawings and are not intended to limit the present disclosure.

In addition, when one element or layer is “on” or “above” another element or layer or is “connected to” the another element or layer, it may be understood that the element or layer is directly on the another element or layer or directly connected to the another element or layer, and alternatively, another element or layer may be between the element or layer and the another element or layer (indirectly). On the contrary, when the element or layer is “directly on” the another element or layer or is “directly connected to” the another element or layer, it may be understood that there is no intervening element or layer between the element or layer and the another element or layer.

The term “electrically connected” includes means of direct or indirect electrical connection. Two elements electrically connected to each other may be in direct contact with each other to transfer electrical signals, and there is no other element between them. Alternatively, two elements electrically connected to each other may be bridged through another element between them to transfer electrical signals. The term “electrically connected” may also be referred to as “coupled”.

As disclosed herein, the terms “approximately”, “essentially”, “about”, or “substantially” generally mean within 20%, 10%, 5%, 3%, 2%, 1%, or 0.5% of the reported numerical value or range.

It should be understood that according to the following embodiments, features of different embodiments may be replaced, recombined or mixed to constitute other embodiments without departing from the spirit of the present disclosure. The features of various embodiments may be mixed arbitrarily and used in different embodiments without departing from the spirit of the present disclosure or conflicting.

In the present disclosure, the length, thickness, width, height, distance, and area may be measured by using an optical microscope (OM), a scanning electron microscope (SEM) or other approaches, but not limited thereto.

Unless otherwise defined, all terms (including technical and scientific terms) used herein have the same meaning as commonly understood by those skilled in the art. It should be understood that these terms, such as those defined in commonly used dictionaries, should be interpreted as having meaning consistent with the relevant technology and the background or context of the present disclosure, and should not be interpreted in an idealized or excessively formal way, unless there is a specific definition in the embodiments of the present disclosure.

An electronic device of the present disclosure may, for example, include a display device, a sensing device, an antenna device, a touch device, a tiled device or other suitable electronic devices, but not limited thereto. The display device of the present disclosure may be any kind of display device, such as a self-emitting display device or a non-self-emitting display device. The self-emitting display device may include a light emitting diode, a light conversion layer, other suitable materials, or any combination of the aforementioned materials, but not limited thereto. The light emitting diode may, for example, include an organic light emitting diode (OLED), a mini light emitting diode (mini LED), a micro light emitting diode (micro LED), a quantum dot light emitting diode (e.g., QLED or QDLED), but not limited thereto. The light conversion layer may include a wavelength conversion material and/or a light filtering material, and the light conversion layer may, for example, include a fluorescent material, a phosphor material, a quantum dot material, other suitable materials, or any combination of elements mentioned above, but not limited thereto. The non-self-emitting display device may include a liquid crystal display device, but not limited thereto. A type of the liquid crystal display device may, for example, be a fringe field switching (FFS) type, an in-plane switching (IPS) type, or other suitable types. The sensing device may, for example, be a sensing device used for detecting variation in capacitances, light, heat, or ultrasound, but not limited thereto. The sensing device may, for example, include a biosensor, a touch sensor, a fingerprint sensor, other suitable sensors, or any combination of sensors mentioned above. The antenna device may, for example, include liquid crystal antenna or antennas of other types, but not limited thereto. The tiled device may, for example, include a tiled display device or a tiled antenna device, but not limited thereto. Furthermore, the appearance of the electronic device may be, for example, rectangular, circular, polygonal, a shape with curved edges, curved or other suitable shapes. The electronic device may be a bendable or a flexible electronic device. The electronic device may have peripheral systems such as a driving system, a control system, a light source system, a shelf system, etc. The electronic device may include electronic units, in which the electronic units may include a passive element and an active element, and for example include a capacitor, a resistor, an inductor, a diode, a transistor, a sensor, etc. It is noted that the electronic device of the present disclosure may be any combination of the above-mentioned devices, but not limited thereto. The electronic device in the following contents takes the liquid crystal display device for example, but the present disclosure is not limited thereto.

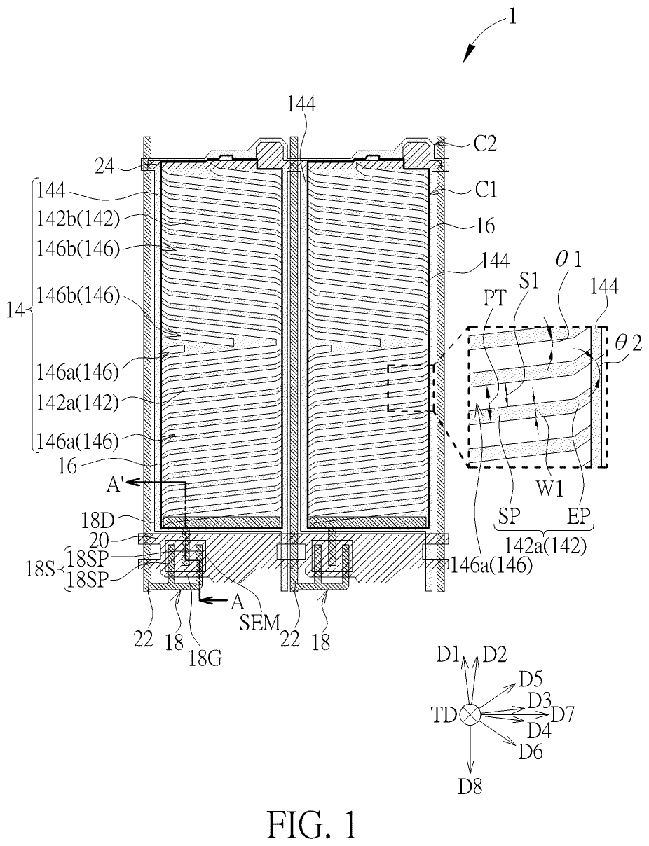

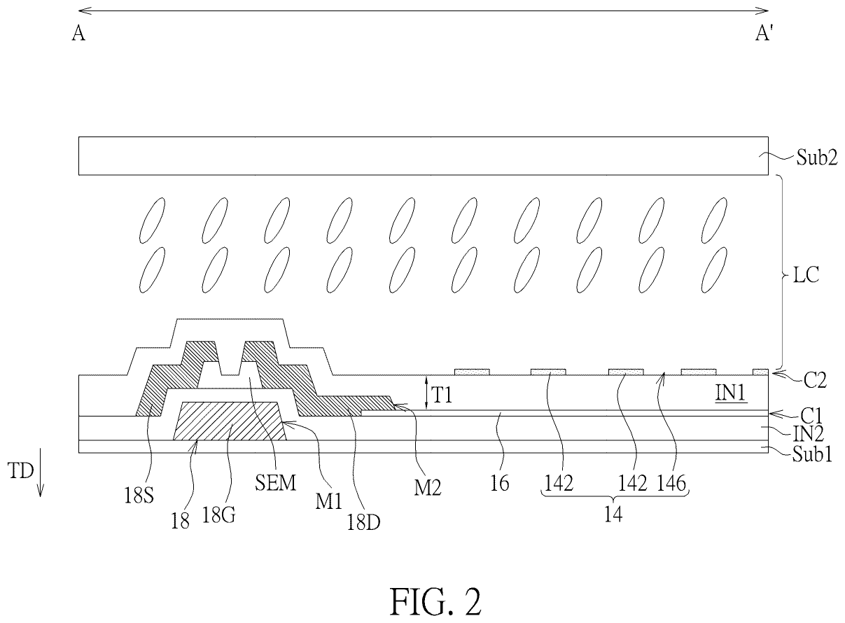

Refer to FIG. 1 and FIG. 2. FIG. 1 schematically illustrates a top view of an electronic device according to a first embodiment of the present disclosure, and FIG. 2 schematically illustrates a cross-sectional view along a line A-A′ in FIG. 1. As shown in FIG. 1 and FIG. 2, an electronic device 1 may include a substrate Sub1, a first transparent conductive layer C1, an insulating layer IN1, and a second transparent conductive layer C2, wherein the first transparent conductive layer C1 is disposed on the substrate Sub1, the insulating layer IN1 is disposed on the first transparent conductive layer C1, and the second transparent conductive layer C2 is disposed on the insulating layer IN1. The substrate Sub1 may be a rigid substrate, a flexible substrate, or a combination of the aforementioned substrates. For example, a material of the substrate Sub1 may include glass, quartz, sapphire, ceramic, polycarbonate (PC), polyimide (PI), polyethylene terephthalate (PET), other suitable substrate material, or any combination of the aforementioned materials. The second transparent conductive layer C2 includes a first transparent electrode 14, and the first transparent electrode 14 includes a plurality of finger portions 142, a connecting portion 144, and at least one slit 146. The connecting portion 144 is connected to the finger portions 142, and the slit 146 is disposed between two adjacent finger portions 142, wherein each of the finger portions 142 has a width W1 in a first direction (e.g., a direction D1 or a direction D2), and a distance S1 is between the two adjacent finger portions 142 in the first direction. The distance S1 may also be referred to as a width of the slit 146 in the first direction. In addition, the insulating layer IN1 has a thickness T1, and a relation of a ratio of the distance S1 to the width W1 and the thickness T1 complies with a following equation:

1.450×X+0.877≤Y≤1.450×X+1.177,

wherein X is the thickness T1 of the insulating layer IN1, a unit of the thickness T1 is micrometer (μm), and Y is the ratio of the distance S1 to the width W1. It is worth noting that through the design of the thickness T1 of the insulating layer IN1 and the ratio of the distance S1 between the two adjacent finger portions 142 (i.e., the width of the slit 146) to the width W1 of the finger portion 142 complying with the above-mentioned equation, the degree of visibility of the Mura phenomenon and/or the probability of occurrence of the Mura phenomenon produced on the image due to process variations may be reduced.

As shown in FIG. 2, the insulating layer IN1 may be used for electrically insulating the first transparent electrode 14 from a second transparent electrode 16. The insulating layer IN1 may, for example, include silicon nitride, silicon oxide, silicon oxynitride, or other suitable dielectric materials to meet the electrical requirement of the electronic device 1. The thickness T1 may, for example, be greater than or equal to 0.05 micrometers and less than or equal to 0.7 micrometers (i.e., 0.05 μm≤T1≤0.7 μm), may be greater than or equal to 0.09 micrometers and less than or equal to 0.65 micrometers (i.e., 0.09 μm≤T1≤0.65 μm), or may be greater than or equal to 0.12 micrometers and less than or equal to 0.6 micrometers (i.e., 0.12 μm≤T1≤0.6 μm). Since the insulating layer IN1 may also be used as a dielectric layer of a storage capacitor, as the thickness T1 of the insulating layer IN1 is greater than 0.7 micrometers, the displayed image may be prone to flicker, and as the thickness T1 of the insulating layer IN1 is less than 0.05 micrometers, the displayed image may be prone to delay or have an error. By designing the thickness T1 of the insulating layer IN1 to be in the aforementioned ranges, the probability of the image of the electronic device 1 flickering may be reduced, and/or the image lagging or committing an error may be reduced. In the embodiment of FIG. 2, a lower surface of the insulating layer IN1 may be in contact with the first transparent conductive layer C1, and an upper surface of the insulating layer IN1 may be in contact with the second transparent conductive layer C2, but not limited thereto.

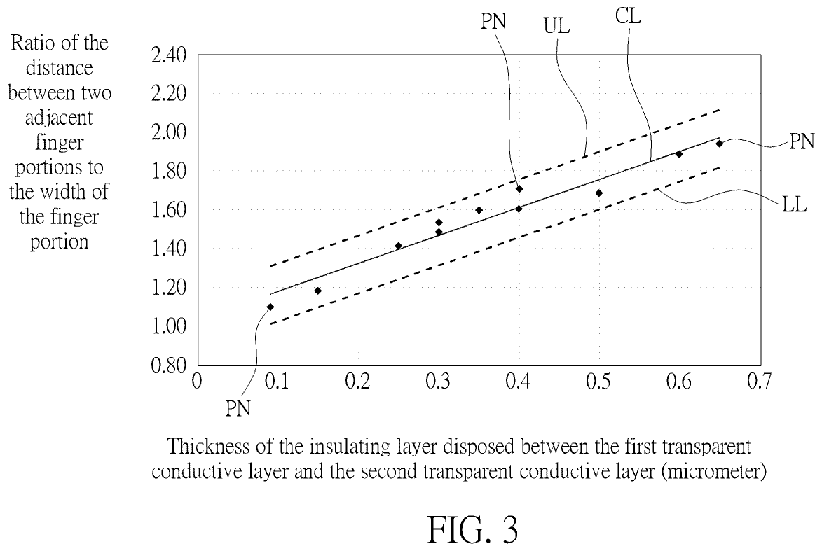

Refer to FIG. 3. FIG. 3 schematically illustrates the relation of the ratio of the distance between two adjacent finger portions to the width of the finger portion and the thickness of the insulating layer of the present disclosure. As shown in FIG. 3, points PN may respectively represent the ratios of the distances between two adjacent finger portions to the widths of the finger portions as the insulating layer of the electronic device has different thicknesses under the condition that the electronic device does not have the Mura phenomenon. The electronic device represented in FIG. 3 may, for example, be the electronic device 1 shown in FIG. 1 and FIG. 2, an electronic device of any one of the following embodiments, or another electronic device with similar structure. Through the distribution of the points PN representing the qualified electronic device, a correlation line CL capable of optimizing the electronic device may be obtained, such that an allowable range of the ratio of the distance S1 between two adjacent finger portions 142 to the width W1 of the finger portion 142 with respect to the different thickness T1 of the insulating layer IN1 may be obtained. That is, an upper limit of the ratio is a line UL, and a lower limit of the ratio is a line LL. In FIG. 3, the line UL may represent an equation: Y=1.450×X+0.877, the line LL may represent an equation: Y=1.450×X+1.177, and the line CL may represent an equation: Y=1.450×X+1.027, wherein X is the thickness T1, the unit of the thickness T1 is micrometer, and Y is the ratio.

It is noted that due to the process variation in the factory, the width W1 of the finger portion 142 may be varied, such as subtracting a variation value or adding the variation value. The variation value may, for example, be less than or equal to 0.9 micrometers. When the ratio is not between the line UL and the line LL, a brightness difference of different pixels or sub-pixels displaying with low gray scale value (e.g., 25% of the maximum gray scale value) or middle gray scale value (e.g., 50% of the maximum gray scale value) may reach 55% of a standard value. The standard value may, for example, be a maximum brightness of the pixel or the sub-pixel displaying with low gray scale value or middle gray scale value. Besides, when the ratio is not between the line UL and the line LL, the brightness of the pixel or the sub-pixel displaying with low gray scale value or middle gray scale value as the width W1 of the finger portion 142 subtracts the variation value is different from the brightness of the pixel or the sub-pixel displaying with low gray scale value or with middle gray scale value as the width W1 of the finger portion 142 adds the variation value, which consequently causes uneven brightness. However, when the ratio is between the line UL and the line LL, the brightness difference of different pixels or sub-pixels displaying with low gray scale value or with middle gray scale value may be reduced to 25% of the standard value, such that the risk of the electronic device producing the Mura phenomenon may be significantly reduced. In addition, when the ratio is between the line UL and the line LL, the brightness of the pixel or the sub-pixel displaying with low gray scale value or middle gray scale value as the width W1 of the finger portion 142 subtracts the variation value is identical or similar to the brightness of the pixel or the sub-pixel displaying with low gray scale value or middle gray scale value as the width W1 of the finger portion 142 adds the variation value, which may produce even brightness change when the factory maintain the even variation value. Accordingly, the electronic device may produce even brightness while displaying with low gray scale value or middle gray scale value.

As shown in FIG. 1 to FIG. 3, since the ratio of the distance S1 between two adjacent finger portions 142 to the width of the finger portion 142 is related to the thickness T1 of the insulating layer IN1, under the condition of reducing the image from flickering and/or reducing the image from delay or having an error, the ratio of the distance S1 to the width W1 may, for example, be greater than or equal to 0.9 and less than or equal to 2.1 (i.e., 0.9≤the ratio≤2.1), or may be greater than or equal to 1 and less than or equal to 2 (i.e., 1≤the ratio≤2) to reduce the probability of the image displaying with the Mura phenomenon. Accordingly, the product yield may be enhanced.

In addition, as shown in FIG. 1, a sum of the width W1 of the finger portion 142 and the distance S1 between two adjacent finger portions 142 may alternatively be referred to as a pitch PT of the finger portions 142, such as a distance between a side edge of one of two adjacent finger portions 142 and a corresponding edge of the other one of the two adjacent finger portions 142. In an embodiment, the pitch PT of the finger portions 142 may, for example, be greater than or equal to 2 micrometers and less than or equal to 12 micrometers (i.e., 2 μm≤PT≤12 μm). The pitch PT of the finger portions 142 may, for example, be any value within the aforementioned range. As the pitch PT of the finger portions 142 decreases, the resolution of the image displayed by the electronic device 1 may increase.

Furthermore, as shown in FIG. 2, the electronic device 1 may further optionally include an opposite substrate Sub2 and a liquid crystal layer LC, and the liquid crystal layer LC is disposed between the second transparent conductive layer C2 and the opposite substrate Sub2. A material of the opposite substrate Sub2 may be referred to the description of the material of the substrate Sub1, and hence, it will not be detailed redundantly herein. The opposite substrate Sub2 may, for example, be a color filter substrate including color filters and a black matrix, but not limited thereto. In some embodiments, the opposite substrate Sub2 may further include other elements, such as a planarization layer and an alignment layer, according to requirements. In some embodiments, the electronic device 1 may further include another alignment layer disposed between the second transparent conductive layer C2 and the liquid crystal layer LC.

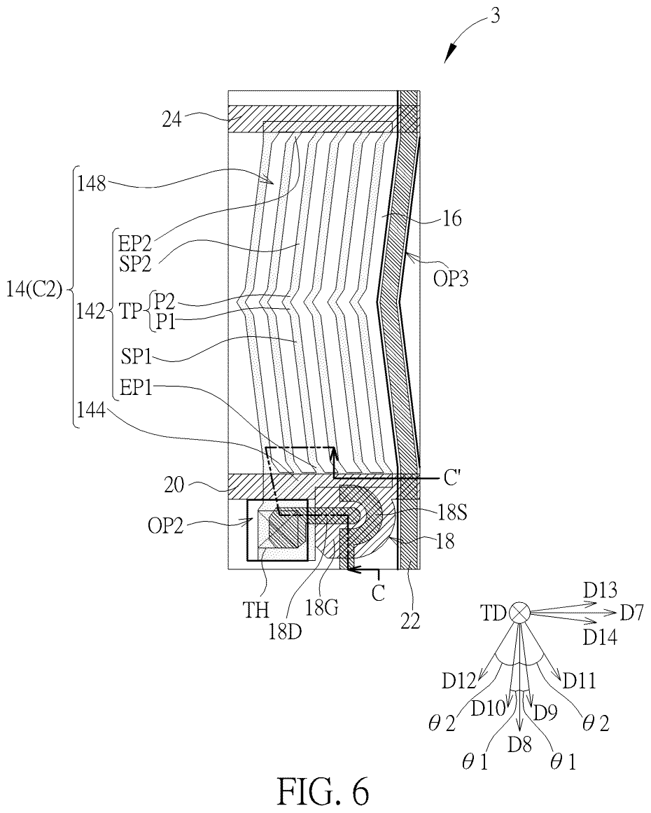

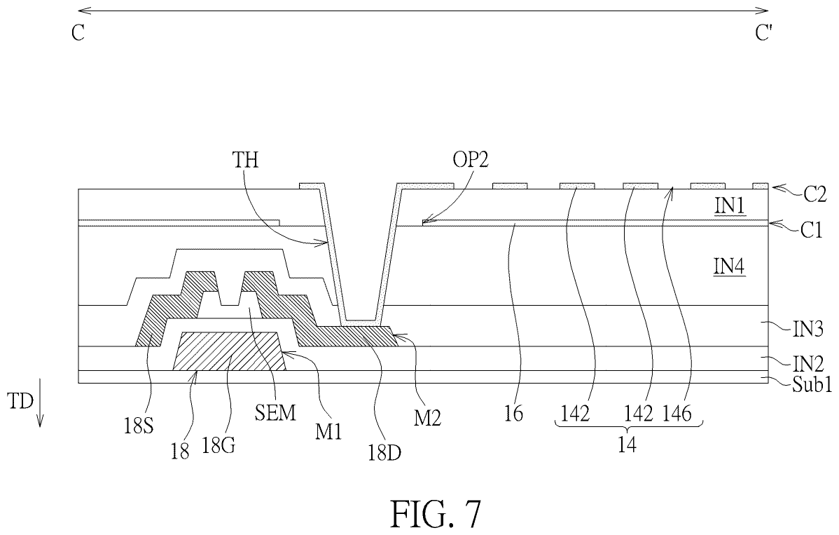

In the embodiment of FIG. 1 and FIG. 2, the first transparent electrode 14 may be a common electrode, and the first transparent conductive layer C1 may include a plurality of second transparent electrodes 16 respectively used as pixel electrodes. The slits 146 of the first transparent electrode 14 may be overlapped with the corresponding one of the second transparent electrodes 16 in a top view direction TD of the electronic device 1, and hence, by providing a voltage difference between the first transparent electrode 14 and the second transparent electrode 16, an electric field from the second transparent electrode 16 may pass through the slits 146 of the first transparent electrode 14 to form a horizontal electric field in the liquid crystal layer LC. Accordingly, an orientation of liquid crystal molecules in the liquid crystal layer LC may be controlled to adjust the gray scale value of the pixel or the sub-pixel. In an embodiment, each of the second transparent electrodes 16 may, for example, not include a slit, but not limited thereto. In some embodiments, the first transparent electrode 14 and the second transparent electrode 16 may respectively be used as a pixel electrode and a common electrode. Under this circumstance, the second transparent conductive layer C2 may include the plurality of first transparent electrodes 14 respectively spaced apart and electrically insulated from each other to be respectively used as the pixel electrodes, and the second transparent electrodes 16 of the first transparent conductive layer C1 may be connected to each other to form single second transparent electrode 16 to be used as the common electrode, for example, as shown in FIG. 6 and FIG. 7. The top view direction TD may, for example, be parallel to a normal direction of an upper surface of the substrate Sub1.

As shown in FIG. 1, the second transparent electrodes 16 may be arranged in an array or other suitable arrangements. The first transparent electrode 14 may be overlapped with the second transparent electrodes 16 in the top view direction TD of the electronic device 1, but not limited thereto. In order to clearly describe the structure of the first transparent electrodes 14, the following contents use the finger portions 142, the connecting portion 144, and the slits 146 of the first transparent electrode 14 corresponding to single second transparent electrode 16 for specifications, but not limited thereto.

As shown in FIG. 1, each of the finger portions 142 may include an end portion EP disposed at an end of the finger portion 142, wherein the end portion EP may be connected to the connecting portion 144, such that the connecting portion 144 may be electrically connected to the plurality of finger portions 142. In the embodiment of FIG. 1, each of the finger portions 142 may further include a strip portion SP connected to the end portion EP, such that the strip portion SP may be electrically connected to the connecting portion 144 through the end portion EP. The strip portion SP may be the majority portion of the finger portion 142, and hence, a length of the strip portion SP may be greater than a length of the end portion EP. The strip portion SP may, for example, have an even width and may, for example, be the width W1 of the aforementioned finger portion 142, but not limited thereto. The end portion EP may also have an even width, for example identical to the width of the strip portion SP, but not limited thereto.

In the embodiment of FIG. 1, the first transparent electrode 14 may include two connecting portions 144 respectively disposed on two ends of each of the finger portions 142, and the majority of the finger portions 142 may include two end portions EP respectively disposed on two ends of the strip portion SP to connect the strip portion SP to the different connecting portions 144, but not limited thereto. Since the two end portions EP may extend along the same direction and may have identical or similar structure, they may be referred to the above-mentioned contents and will not be detailed redundantly herein. In some embodiments, the quantity of the connecting portions 144 and the quantity of the end portions EP are not limited to that is shown in FIG. 1 and may respectively be at least one.

Besides, the strip portion SP may extend along a direction, for example extending along a direction D3 or a direction D4, and the end portion EP may extend along another direction different from the extending direction of the strip portion SP, for example extending along a direction D5 or a direction D6. In the embodiment of FIG. 1, an angle θ1 between the extending direction of the strip portion SP and a second direction (i.e., a horizontal direction D7) perpendicular to the extending direction of the connecting portion 144 may be greater than or equal to 0 degree and less than or equal to 24 degrees (that is 0°≤θ1≤24°) to facilitate enhancing the brightness of the image displayed by the electronic device 1. The angle θ1 may, for example, be 7 degrees. An angle θ2 between the extending direction of the end portion EP and the horizontal direction D7 may be greater than or equal to 24 degrees and less than or equal to 40 degrees (i.e., 24°≤θ2≤40°) to facilitate shrinking dark stripes, such that the probability of producing dark stripes may be reduced. The angle θ2 may, for example, be 32 degrees. The horizontal direction D7 may, for example, be a row direction of the second transparent electrodes 16, but not limited thereto.

Specifically, in the embodiment of FIG. 1, the finger portions 142 may be divided into or include a plurality of first finger portions 142a and a plurality of second finger portions 142b, and the strip portions SP of the first finger portions 142a and the strip portions SP of the second finger portions 142b may respectively extend along the direction D3 and the direction D4 different from the direction D3. For example, the angle θ1 between the extending direction of the strip portion SP of one of the first finger portions 142a (e.g., the direction D3) and the horizontal direction D7 and the angle θ1 between the extending direction of the strip portion SP of one of the second finger portions 142b (e.g., the direction D4) and the horizontal direction D7 may be greater than or equal to 0 degree and less than or equal to 24 degrees (i.e., 0°≤θ1≤24°). For example, the angle θ2 between the extending direction of the end portion EP of one of the first finger portions 142a (e.g., the direction D5) and the horizontal direction D7 and the angle θ2 between the extending direction of the end portion EP of one of the second finger portions 142b (e.g., the direction D6) and the horizontal direction D7 may be equal to each other, and may be greater than or equal to 24 degrees and less than or equal to 40 degrees (i.e., 24°≤θ2≤40°). In an embodiment, the direction D3 and the direction D4 may be symmetrical to each other with respect to the horizontal direction D7 as an axis of symmetry, and the direction D5 and the direction D6 may be symmetrical to each other with respect to the horizontal direction D7 as an axis of symmetry, but not limited thereto.

As shown in FIG. 1, the first finger portions 142a and the second finger portions 142b may respectively be arranged in a vertical direction D8 different from the horizontal direction D7. The horizontal direction D7 and the vertical direction D8 may, for example, be perpendicular to each other, and the vertical direction D8 may, for example, be a column direction of the second transparent electrodes 16, but not limited thereto. In the embodiment of FIG. 1, the first finger portions 142a may be overlapped with a lower half portion of the second transparent electrode 16, and the second finger portions 142b may be overlapped with an upper half portion of the second transparent electrode 16, but not limited thereto. In some embodiments, the finger portions 142 corresponding to the same second transparent electrode 16 may all be the first finger portions 142a or may all be the second finger portions 142b, but not limited thereto. The finger portions 142 corresponding to the different second transparent electrodes 16 may, for example, have identical structure, but not limited thereto.

In this embodiment, the first transparent electrode 14 may include the plurality of slits 146 corresponding to the same second transparent electrode 16, but not limited thereto. Under this condition, the slits 146 may be divided into or include a plurality of first slits 146a and a plurality of second slits 146b, wherein the first slit 146a is disposed between two adjacent first finger portions 142a, and the second slit 146b is disposed between two adjacent second finger portions 142b. In the embodiment of FIG. 1, a length of the first slit 146a closest to the second finger portions 142b and a length of the second silt 146b closest to the first finger portions 142a may be less than the lengths of the other first slits 146a and the lengths of the other second slits 146b, but not limited thereto. Under this condition, the first finger portions 142a disposed on two sides of the first slit 146a closest to the second finger portions 142b may be connected to the second finger portions 146b disposed on two sides of the second slit 146b closest to the first finger portions 146a, but not limited thereto.

In addition, as shown in FIG. 1 and FIG. 2, the electronic device 1 may further include a switching element 18 disposed between the substrate Sub1 and the insulating layer IN1, and the first transparent conductive layer C1 is electrically connected to the switching element 18. Specifically, in the embodiment of FIG. 1, the electronic device 1 may include the plurality of switching elements 18 respectively electrically connected to the corresponding second transparent electrodes 16. The electronic device 1 may further include a plurality of signal lines used to transmit switching signals controlling the switching elements 18, voltage signals of the second transparent electrodes 16, or other suitable signals. The signal lines may, for example, include scanning lines 20, data lines 22, and common lines 24, but not limited thereto. In an embodiment, the scanning lines 20 may respectively extend along the horizontal direction D7 and arranged in the horizontal direction D8. The data lines 22 may respectively extend along the vertical direction D8 and arranged in the horizontal direction D7, wherein the data lines 22 may intersect with the scanning lines 20 in the top view direction TD of the electronic device 1. Each of the second transparent electrodes 16 may respectively be disposed in a region surrounded by two adjacent scanning lines 20 and two adjacent data lines 22, but not limited thereto.

As shown in FIG. 1, each of the switching elements 18 may include a gate 18G, a source 18S, and a drain 18D, wherein the gate 18G may be formed of a portion of the corresponding scanning line 20 and electrically connected to the corresponding scanning line 20, the source 18S may be electrically connected to the corresponding data line 22, and the drain 18D may be electrically connected to the second transparent electrode 16. Besides, each of the switching elements 18 may further include a semiconductor layer SEM disposed corresponding to the gate 18G. The switching element 18 may, for example, include a thin film transistor and may be any type of thin film transistor.

In the embodiment of FIG. 2, the switching element 18 takes a bottom-gate type thin film transistor for example to specify, but not limited thereto. Specifically, the electronic device 1 may include a first metal layer M1, an insulating layer IN2, the semiconductor layer SEM, and a second metal layer M2. The gate 18G may be disposed on the substrate Sub1, and the gate 18G and the scanning lines 20 may, for example, be formed of the first metal layer M1. The insulating layer IN2 is disposed on the gate 18G and the substrate Sub1. The insulating layer IN2 may be used as a gate insulating layer of the switching element 18 and may, for example, include silicon oxide, silicon nitride, silicon oxynitride, or other suitable insulation materials. The semiconductor layer SEM may be disposed on the insulating layer IN2 and may be overlapped with the gate 18G in the top view direction TD. The source 18S and the drain 18D may be respectively disposed on two opposite sides of the semiconductor layer SEM, and may, for example, be formed of the second metal layer M2. The data lines 22 may also be formed of the second metal layer M2, but not limited thereto. The source 18S and the drain 18D may extend onto the insulating layer IN2, and the first transparent conductive layer C1 may be disposed on the insulating layer IN2, such that the drain 18D may be connected to the second transparent electrode 16. In FIG. 2, the drain 18D may be disposed on a portion of the second transparent electrode 16 and may be directly connected to the second transparent electrode 16, but not limited thereto. In some embodiments, the second transparent electrode 16 may alternatively be disposed on the drain 18D. In addition, the insulating layer IN1 may be disposed on the first transparent conductive layer C1 and the second metal layer M2, and the second transparent conductive layer C2 may be disposed on the insulating layer IN1.

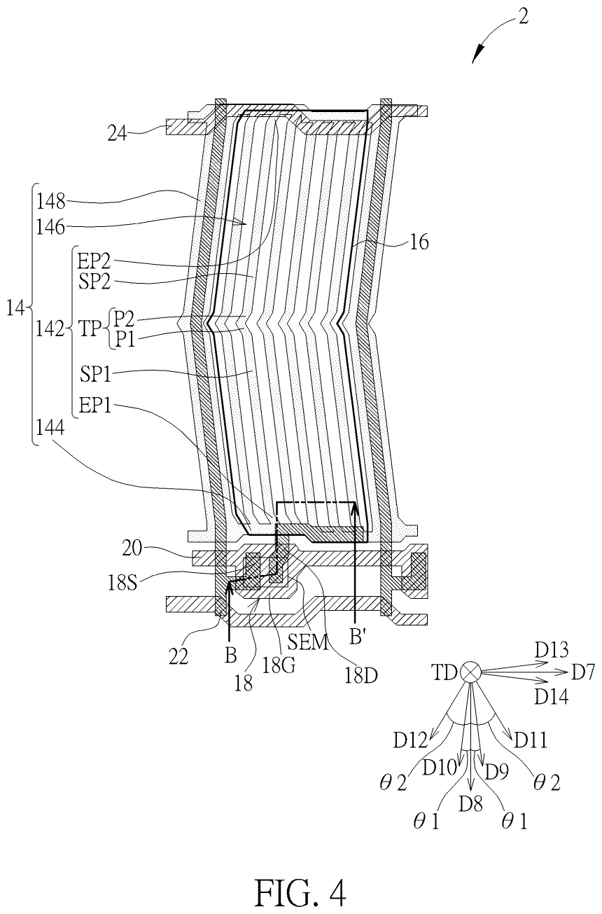

In some embodiments, as shown in FIG. 1, the source 18S may include two portions 18SP respectively disposed on two sides of a portion of the drain 18D overlapped with the semiconductor layer SEM to facilitate enhancing an on-state current of the switching element 18. In other words, viewing in the top view direction TD, the source 18S may have a U-shaped structure, and the drain 18D may extend into a concavity of the U-shaped structure, but not limited thereto. In some embodiments, the switching element 18 may alternatively be as shown in FIG. 4.

The electronic device of the present disclosure is not limited to the above-mentioned embodiments and may have other embodiments. To simplify description, other embodiments in the following contents will use the same notations to label the same elements as the aforementioned embodiment. To clearly clarify other embodiments, the following contents will emphasize on the differences between other embodiments and the above-mentioned embodiment, and will not further elaborate for the repeated part.

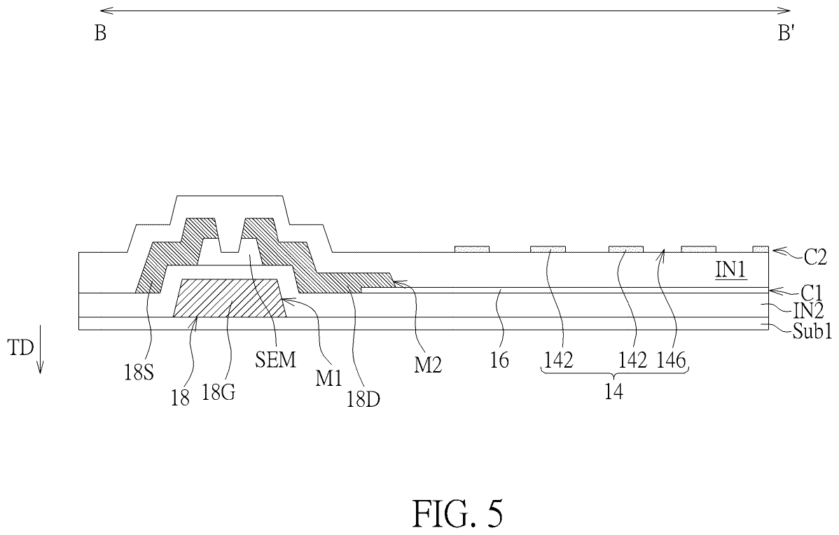

Refer to FIG. 4 and FIG. 5. FIG. 4 schematically illustrates a top view of an electronic device according to a second embodiment of the present disclosure. FIG. 5 schematically illustrates a cross-sectional view along a line B-B′ in FIG. 4. As shown in FIG. 4 and FIG. 5, an electronic device 2 provided by this embodiment differs from the electronic device 1 of FIG. 1 in the structure of the finger portions 142. Specifically, one of the finger portions 142 of this embodiment may include an end portion EP1, a first strip portion SP1, a turning portion TP, and a second strip portion SP2, wherein the first strip portion SP1 is connected to the end portion EP1, and the turning portion TP is connected between the first strip portion SP1 and the second strip portion SP2. The first strip portion SP1 may extend along a direction D9, and the second strip portion SP2 may extend along a direction D10. In the embodiment of FIG. 4, the angle θ1 between the direction D9 and the vertical direction D8 may be greater than or equal to 0 degree and less than or equal to 24 degrees (that is 0°θ1≤24°) to facilitate enhancing the brightness of the image displayed by the electronic device 2. The angle θ1 may, for example, be 7 degrees. Since the direction D9 and the direction D10 may be symmetrical to each other with respect to the vertical direction D8 as an axis of symmetry, the angle θ1 between the direction D10 and the vertical direction D8 may also be greater than or equal to 0 degree and less than or equal to 24 degrees (i.e., 0°≤θ1≤24°). The end portion EP1 may extend along a direction D11, and the angle θ2 between the direction D11 and the vertical direction D8 may be greater than or equal to 24 degrees and less than or equal to 40 degrees (i.e., 24°≤θ2≤40°) to facilitate shrinking dark stripes, such that the probability of producing dark stripes may be reduced. The angle θ2 may, for example, be 32 degrees.

It is noted that the width W1 of the finger portion 142 may be referred to as the width of the first strip portion SP1 in a direction D13 perpendicular to the direction D9 or the width of the second strip portion SP2 in a direction D14 perpendicular to the direction D10. Similarly, the distance S1 between two adjacent finger portions 142 may be referred to as the distance between two adjacent first strip portions SP1 or the distance between two adjacent second strip portions SP2.

In the embodiment of FIG. 4, the first transparent electrode 14 may optionally include two of the connecting portions 144. Under this circumstance, the first transparent electrode 14 may further include another end portion EP2, and the connecting portions 144 may respectively be connected to the end portion EP1 and the end portion EP2, but not limited thereto. The end portion EP2 may extend along the direction D12, and the direction D12 and the extending direction D11 of the end portion EP1 may be symmetrical to each other with respect to the vertical direction D8 as an axis of symmetry. The angle θ2 between the direction D12 and the vertical direction D8 may be greater than or equal to 24 degree and less than or equal to 40 degrees (i.e., 24°≤θ2≤40°). For example, one of the end portions EP1 may be symmetrical to corresponding one of the end portions EP2 with respect to the horizontal direction D7 as an axis of symmetry, but not limited thereto.

Furthermore, the turning portion TP may include a first portion P1 and a second portion P2, wherein the first portion P1 and the second portion P2 are connected to each other and respectively extend along different directions. The first portion P1 may be connected to the first strip portion SP1, and the second portion P2 may be connected to the second strip portion SP2. In the embodiment of FIG. 4, the first portion P1 may extend along the direction D11, which is identical to the end portion EP1, and the second portion P2 may extend along the direction D12, which is identical to the end portion EP2, but not limited thereto. In an embodiment, the first portion P1 and the second portion P2 may be symmetrical to each other with respect to the horizontal direction D7 as an axis of symmetry, but not limited thereto.

In some embodiments, the first transparent electrode 14 may further optionally include a connecting portion 148 used to electrically connect the two connecting portions 144 to each other. The connecting portion 148 may, for example, be overlapped with the corresponding data line 22 in the top view direction TD. In some embodiments, the connecting portion 148 may be parallel to the finger portion 142, and a portion of the data line 22 corresponding to the connecting portion 148 may also be parallel to the finger portion 142, but not limited thereto.

In the embodiment of FIG. 4, the switching element 18 may alternatively be other types of thin film transistor. Besides, since other parts of the electronic device 2 of this embodiment may be identical to the electronic device 1 of FIG. 1 and FIG. 2, they may be referred to the aforementioned contents and will not be detailed redundantly herein.

Refer to FIG. 6 and FIG. 7. FIG. 6 schematically illustrates a top view of an electronic device according to a third embodiment of the present disclosure. FIG. 7 schematically illustrates a cross-sectional view along a line C-C′ in FIG. 6. As shown in FIG. 6 and FIG. 7, an electronic device 3 provided by this embodiment differs from the electronic device 2 of FIG. 3 and FIG. 4 in that the first transparent electrode 14 and the second transparent electrode 16 are respectively used as the pixel electrode and the common electrode. Under this condition, the second transparent conductive layer C2 may include a plurality of the first transparent electrodes 14 spaced apart and electrically insulated from each other, and the first transparent electrodes are respectively used as the pixel electrodes. The second transparent electrode 16 of the first transparent conductive layer C1 may be the single second transparent electrode 16 corresponding to the first transparent electrodes 14 and may be used as the common electrode. Under this circumstance, the switching elements 18 may be disposed between the substrate Sub1 and the insulating layer IN1, and the first transparent electrodes 14 of the second transparent conductive layer C2 may respectively be electrically connected to the corresponding switching elements 18. In order to clearly illustrate the structure of the first transparent electrodes 14, FIG. 6 illustrates the single first transparent electrode 14 and a portion of the second transparent electrode 16 corresponding to the single first transparent electrode 14, but not limited thereto.

Specifically, as shown in FIG. 6 and FIG. 7, the electronic device 3 may further include an insulating layer IN3 and the insulating layer IN4 sequentially disposed between the insulating layer IN2 and the first transparent conductive layer C1. The insulating layer IN3, the insulating layer IN4, and the insulating layer IN1 may include a through hole TH, such that the first electrode 14 may be electrically connected to the drain 18D of the switching element 18 through the through hole TH. Under this circumstance, the second transparent electrode 16 may include an opening OP2 corresponding to the through hole TH in the top view direction. The insulating layer IN3 may, for example, include inorganic insulation material or other suitable insulation materials to protect the switching elements 18. The insulating layer IN4 may, for example, include organic insulation material or other suitable insulation materials to have a flat upper surface, so as to facilitate forming the flat second transparent electrode 16. In some embodiments, the second transparent electrode 16 may further include another opening OP3 overlapped with a portion of the data line 22 in the top view direction TD, but not limited thereto.

As shown in FIG. 6, the first transparent electrode 14 may include the plurality of finger portions 142, the connecting portion 144, and at least one slit 146. Since the finger portions 142 of FIG. 6 may be identical or similar to the finger portions 142 of FIG. 4, they may be referred to the aforementioned contents and will not be detailed redundantly herein. In the embodiment of FIG. 6, the connecting portion 144 may extend into the through hole TH to be electrically connected to the drain 18D, but not limited thereto. In some embodiments, the first transparent electrode 14 may alternatively optionally include two connecting portions 144. Under this condition, the first transparent electrode 14 may further include another end portion EP2, and the connecting portions 144 may respectively be connected to the end portion EP1 and the end portion EP2, but not limited thereto. In addition, since other parts of the electronic device 3 of this embodiment may be identical to the electronic device 1 of FIG. 1 and FIG. 2 or the electronic device 2 of FIG. 4 and FIG. 5, they may be referred to the aforementioned contents and will not be detailed redundantly herein.

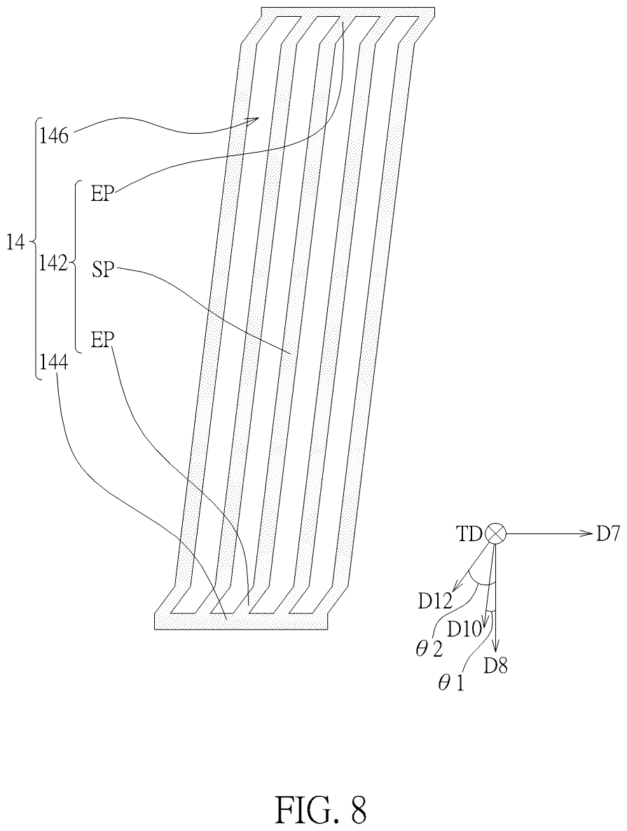

Refer to FIG. 8. FIG. 8 schematically illustrates a top view of a first transparent electrode according to a fourth embodiment of the present disclosure. As shown in FIG. 8, the first transparent electrode 14 provided by this embodiment differs from the first transparent electrode 14 of FIG. 6 in that the first transparent electrode 14 of this embodiment may not include the first strip portions SP1, the end portions EP1, and the first portions P1 of the turning portions TP. In other words, the first transparent electrode 14 may include the end portions EP and the strip portions SP, wherein the end portions EP and the strip portions SP may respectively extend along the direction D12 and the direction D10. The end portions EP and the strip portions SP may, for example, be identical or similar to the second portions P2 of the turning portions TP and the second strip portions SP2, but not limited thereto. In the embodiment of FIG. 8, the end portions EP may be directly connected to the connecting portion 144. In some embodiments, the end portions EP and the strip portions SP may alternatively be respectively extended along the direction D11 and the direction D9 shown in FIG. 6 and may respectively be identical or similar to the first portions P1 of the turning portions TP and the first strip portions SP1 shown in FIG. 6, but not limited thereto. In some embodiments, the first transparent electrode 14 shown in FIG. 8 may be optionally applied to the first transparent electrode of the electronic device according to any one of the aforementioned embodiments.

In summary, in the electronic device of the present disclosure, since the thickness of the insulating layer disposed between the first transparent conductive layer and the second transparent conductive layer and the ratio of the distance between two adjacent ones of the finger portions to the width of the finger portion complies with the above-mentioned equation, the degree of visibility of the Mura phenomenon and/or the probability of occurrence of the Mura phenomenon produced on the image due to process variation may be reduced, such that the display quality and/or the consistency of the quality of the electronic device may be enhanced.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. An electronic device, comprising:
a substrate;
a first transparent conductive layer disposed on the substrate;
an insulating layer disposed on the first transparent conductive layer, and the insulating layer having a thickness; and
a second transparent conductive layer disposed on the insulating layer, wherein the second transparent conductive layer comprises a first transparent electrode, and the first transparent electrode comprises:
a plurality of finger portions, wherein one of the plurality of finger portions has a width in a first direction;
a connecting portion connected to the plurality of finger portions; and
a slit disposed between two adjacent ones of the plurality of finger portions, wherein a distance in the first direction is between the two adjacent ones of the plurality of finger portions,
wherein a relation of a ratio of the distance to the width and the thickness complies with a following equation:
1.450×X+0.877≤Y≤1.450×X+1.177,
wherein X is the thickness, a unit of the thickness is micrometer, and Y is the ratio of the distance to the width.

2. The electronic device according to claim 1, wherein the thickness is greater than or equal to 0.05 micrometers and less than or equal to 0.7 micrometers.

3. The electronic device according to claim 1, wherein a sum of the width and the distance is greater than or equal to 2 micrometers and less than or equal to 12 micrometers.

4. The electronic device according to claim 1, wherein the ratio of the distance to the width is greater than or equal to 0.9 and less than or equal to 2.1.

5. The electronic device according to claim 1, wherein the plurality of finger portions comprises a plurality of first finger portions and a plurality of second finger portions, one of the plurality of first finger portions comprises a strip portion, one of the plurality of second finger portions comprises another strip portion, and an extending direction of the strip portion is different from an extending direction of the another strip portion.

6. The electronic device according to claim 5, wherein the first transparent conductive layer comprises a second transparent electrode, the plurality of first finger portions are overlapped with a portion of the second transparent electrode in a top view direction of the electronic device, and the plurality of second finger portions are overlapped with another portion of the second transparent electrode in the top view direction of the electronic device.

7. The electronic device according to claim 5, wherein the first transparent electrode further comprises another connecting portion, and the connecting portion and the another connecting portion are respectively disposed on two ends of each of the plurality of finger portions.

8. The electronic device according to claim 5, wherein an angle between the extending direction of the strip portion and a second direction perpendicular to an extending direction of the connecting portion is greater than or equal to 0 degree and less than or equal to 24 degrees.

9. The electronic device according to claim 8, further comprising a data line extending along the second direction.

10. The electronic device according to claim 1, wherein one of the plurality of finger portions comprises an end portion connected to the connecting portion.

11. The electronic device according to claim 10, wherein an angle between an extending direction of the end portion and a second direction perpendicular to an extending direction of the connecting portion is greater than or equal to 24 degrees and less than or equal to 40 degrees.

12. The electronic device according to claim 10, wherein the one of the plurality of finger portions further comprises a first strip portion, a turning portion, and a second strip portion, wherein the first strip portion is connected to the end portion, and the turning portion is connected between the first strip portion and the second strip portion.

13. The electronic device according to claim 12, wherein an angle between an extending direction of the first strip portion and a second direction perpendicular to an extending direction of the connecting portion is greater than or equal to 0 degree and less than or equal to 24 degrees.

14. The electronic device according to claim 12, further comprising a scanning line extending along the second direction.

15. The electronic device according to claim 12, wherein the one of the plurality of finger portions further comprises another end portion connected to the second strip portion, and an extending direction of the end portion is different from an extending direction of the another end portion.

16. The electronic device according to claim 1, further comprising a data line, wherein the first transparent conductive layer comprises a second transparent electrode, the second transparent electrode comprises an opening overlapped with a portion of the data line in a top view direction of the electronic device.

17. The electronic device according to claim 1, further comprising a switching element disposed between the substrate and the insulating layer, wherein the first transparent conductive layer further comprises a second transparent electrode, and the second transparent electrode is electrically connected to the switching element.

18. The electronic device according to claim 1, further comprising a switching element disposed between the substrate and the insulating layer, wherein the switching element further comprises a source, a gate, a drain, and a semiconductor layer, the source comprises two portions respectively disposed on two sides of a portion of the drain overlapped with the semiconductor layer.

19. The electronic device according to claim 1, further comprising a switching element disposed between the substrate and the insulating layer, wherein the first transparent electrode is electrically connected to the switching element.

20. The electronic device according to claim 17, further comprising at least another insulating layer disposed between the substrate and the first transparent conductive layer, wherein the at least another insulating layer and the insulating layer comprise a through hole, and the first transparent electrode is electrically connected to the switching element through the through hole.
